(19) United States
(12) Patent Application Publication
(10) Pub. No.: US 2012/0280106 A1
(43) Pub. Date: Nov. 8, 2012

(54) Process for manufacturing a flexible, thin-walled, hollow pancake mold article and a product made thereof

(75) Inventor: David William Mills, Bronte (AU)

(73) Assignee: The Chefs Toolbox Pty. Limited, Sydney (AU)

(21) Appl. No.: 13/068,069

(22) Filed: May 2, 2011

(51) Int. Cl. B29C 39/38; B29C 39/12; B29C 33/40; B29C 71/02; B29C 35/02

(52) U.S. Cl. 249/203; 264/219; 264/161

(57) ABSTRACT

The present invention relates generally to a pancake mold article. More particularly, the invention encompasses a process for manufacturing a flexible, thin-walled, hollow pancake mold article. The present invention is also directed to novel non-metallic pancake mold articles. The present invention also encompasses a product made via the inventive process. The process for manufacturing the flexible, thin-walled, hollow pancake mold article comprises of at least one first vulcanization phase and at least one second vulcanization phase. Between the first and the second vulcanization phase the mold article can optionally be trimmed. The mold article can be wiped and cleaned after the second vulcanization phase. Preferably the mold article material is a food grade silicone, and optionally having at least one color.

### FIELD OF THE INVENTION

The present invention relates generally to a pancake mold article. More particularly, the invention encompasses a process for manufacturing a flexible, thin-walled, hollow pancake mold article. The present invention is also directed to novel non-metallic pancake mold articles. The present invention also encompasses a product made via the inventive process. The process for manufacturing the flexible, thin-walled, hollow pancake mold article comprises of at least one first vulcanization phase and at least one second vulcanization phase. Between the first and the second vulcanization phase the mold article can optionally be trimmed. The mold article can be wiped and cleaned after the second vulcanization phase. Preferably the mold article material is a food grade silicone, and optionally having at least one color.

### BACKGROUND INFORMATION

Food mold articles have been used and are well known in the prior art. A common baking pan is a food mold article, with an open end, a closed end, and a peripheral side wall. The closed end and side wall define a hollow volume that becomes the three-dimensional shape of a food product molded in the baking pan. Multiple cake baking pans are also known and have a tray with a plurality of circular recesses for baking cup cakes and similar other food items.

Some food pans, such as, a baking pan for making angel food cake, have an annular ring shaped with an open end. The hollow volume of the annular ring is filled with a food composition and the contents are then baked. After baking the pan is inverted to remove the shaped food composition from the open end. Thus, the open end is used to form the bottom of the final food product.

Other food mold articles have a centrally located indentation at the closed end. With a mold of this type, a first food composition may be placed and formed in the open end and a second food composition may be placed in the complementary shaped indentation at the closed end. This provides an accurate fit for the second filler food composition within the first supporting food composition.

U.S. Pat. No. 7,011,015 (Nicole M. Marghella), the entire disclosure of which is incorporated herein by reference, discloses a pancake mold which includes a scissor assembly with a first arm connected to a second arm by a pivot pin. Both arms have a handle end and a tool end. A mold cavity former is attached to the tool end of the first arm. A spatula is attached to the tool end of the second arm. Moving the handle on the second arm toward the handle on the first arm moves the spatula under the mold cavity former and a partially cooked pancake in the mold cavity former. The scissor assembly is inverted to discharge a partially cooked pancake from the cavity and onto a grill for continued cooking.

U.S. Pat. No. 7,150,221 (Fletcher Morgan), the entire disclosure of which is incorporated herein by reference, discloses an assembly for forming multiple individual compound desserts in a predetermined dome shape including a base tray having a plurality of recessed cavities to form a base for said compound dessert. A rack and a plurality of dome shaped bowl assemblies is secured in a fixed position to said rack. Each bowl assembly is formed with a closed semi-spherical end and an open end forming a cavity, and a cover member which is mounted over said open end, the cover member having an inner bowl extending therefrom which extends into the cavity.

It can thus be seen that a number of devices have been used in the molding and baking of cakes and pancakes in a variety of shaped utensils and configurations as described in the prior art.

This invention improves on the deficiencies of the prior art, and provides an inventive pancake mold article and a process of manufacturing thereof.

### PURPOSES AND SUMMARY OF THE INVENTION

The invention is a novel pancake mold article and process of manufacturing the same.

Therefore, one purpose of this invention is to provide a process for manufacturing flexible, thin-walled, hollow pancake mold articles.

Another purpose of this invention is to provide a process for manufacturing a novel non-metallic pancake mold article.

Yet another purpose of this invention is to provide a product made by the inventive process of this invention.

Therefore, in one aspect this invention comprises a process for manufacturing a flexible, thin-walled, hollow pancake mold article, comprising the steps of:

(a) pouring silicone in a container, and spinning said silicone to form a spun silicone material;
(b) pouring said spun silicone material inside at least one cavity of a mold forming apparatus, wherein said at least one cavity is in the shape of a thin-walled, hollow pancake mold article;
(c) placing said mold forming apparatus inside a furnace, and heating it for a first set time and a first set temperature, to perform a first vulcanization phase on said spun silicone material;
(d) removing said mold forming apparatus from said furnace after said first set time and said first set temperature;
(e) removing said spun silicone material from said at least one cavity of said mold forming apparatus after said first vulcanization phase;
(f) placing said spun silicone material in a furnace to perform a second vulcanization phase for a second set time and a second set temperature; and
(g) removing said spun silicone material from said furnace after said second vulcanization phase, and thereby forming said flexible, thin-walled, hollow pancake mold article.

In another aspect this invention comprises a process for manufacturing a flexible, thin-walled, hollow pancake mold article, comprising the steps of:

(a) pouring silicone and at least one color in a container, and spinning said silicone and said at least one color, and forming a colored spun silicone material;
(b) pouring said colored spun silicone material inside at least one cavity of a mold forming apparatus, wherein said at least one cavity is in the shape of a thin-walled, hollow pancake mold article;
(c) placing said mold forming apparatus inside a furnace, and heating it for at least about 90 seconds, and to a temperature of at least about 190 degrees centigrade, to perform a first vulcanization phase on said colored spun silicone material;
(d) removing said mold forming apparatus from said furnace after said first vulcanization phase;
(e) removing said colored spun silicone material from said at least one cavity of said mold forming apparatus after said first vulcanization phase;
(f) placing said colored spun silicone material in a furnace to perform a second vulcanization phase for at least about four hours, at a temperature of at least about 200 degrees centigrade; and
(g) removing said colored spun silicone material from said furnace after said second vulcanization phase, and thereby forming said flexible, thin-walled, hollow pancake mold article.

In yet another aspect this invention comprises a product made by the process of manufacturing a flexible, thin-walled, hollow pancake mold article, comprising the steps of:

(a) pouring silicone and at least one color in a container, and spinning said silicone having said at least one color, and forming a colored spun silicone material;
(b) pouring said colored spun silicone material inside at least one cavity of a mold forming apparatus, wherein said at least one cavity is in the shape of a thin-walled, hollow pancake mold article;
(c) placing said mold forming apparatus inside a furnace, and heating it for at least about 90 seconds, and to a temperature of at least about 190 degrees centigrade, to perform a first vulcanization phase on said colored spun silicone material;
(d) removing said mold forming apparatus from said furnace after said first vulcanization phase;
(e) removing said colored spun silicone material from said at least one cavity of said mold forming apparatus after said first vulcanization phase, and trimming said colored spun silicone material;
(f) placing said trimmed colored spun silicone material in a furnace to perform a second vulcanization phase for at least about four hours, at a temperature of at least about 200 degrees centigrade; and
(g) removing said trimmed colored spun silicone material from said furnace after said second vulcanization phase, and wiping and cleaning said trimmed colored spun silicone material, and thereby making said product made by the process of manufacturing a flexible, thin-walled, hollow pancake mold article.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 is a process for manufacturing a flexible, thin-walled, hollow pancake mold article of this invention.

FIG. 2 is a perspective view of a first embodiment of a flexible, thin-walled, hollow pancake mold manufactured according to the process of this invention.

FIG. 3 is a perspective view of a second embodiment of a flexible, thin-walled, hollow pancake mold manufactured according to the process of this invention.

### DETAILED DESCRIPTION

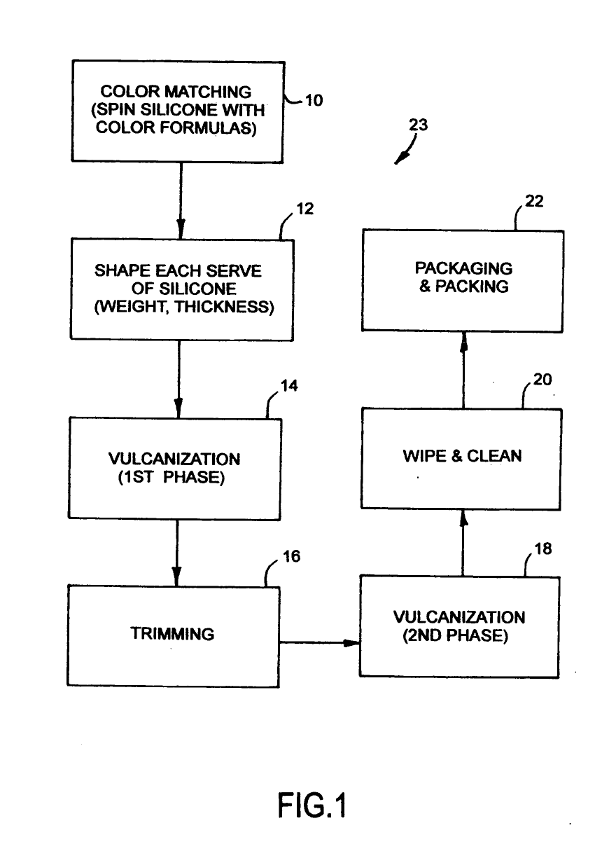

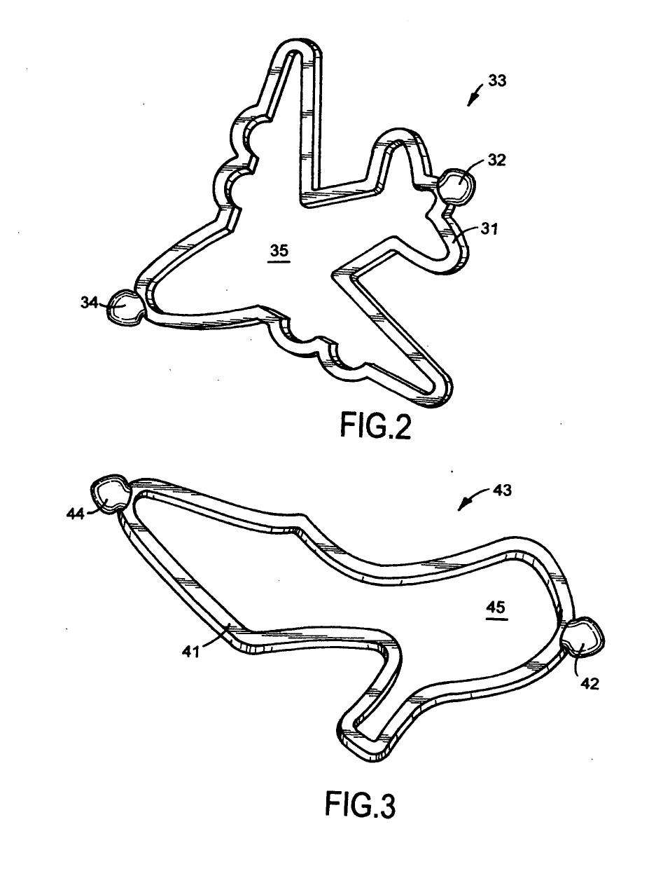

FIG. 1 is a process for manufacturing a thin-walled, hollow pancake mold article 23, of this invention. The process of manufacturing the thin-walled, hollow pancake mold article 23, starts with mixing silicone with at least one color formula at step 10. At step 10, which may be called a color matching step, and where it is preferred that the silicone and at least one color formula are mixed by spinning the mixed ingredients. The colors for the color formula material can be selected from any color that is desired by the client and/or consumer. Some of the colors that may be used for the color formula are selected from a group comprising blue, green, orange, red, yellow, or mixtures thereof, to name a few. The mixed ingredients from step 10, are then inserted into a mold forming apparatus (not shown) at step 12, to create a shape for the molded article. The mold forming apparatus at step 12, are prefabricated and they are well known to the people skilled in the art. It should be understood that the cavity within the mold forming apparatus is of a shape that is desired of the end mold product. For example, if the end mold product desired is an airplane (shown in FIG. 2) then the mold cavity at step 12, is of an airplane mold. It should also be understood that the mold cavity can be for the manufacturing of a single item or for a plurality of items. The mold cavity can be built to accommodate the desired weight of the mold article and/or the desired height and/or thickness of the mold article. The molded raw material from step 10, and contained in the mold forming apparatus of step 12, is then put through a first phase of a vulcanization process at step 14. It is preferred that at the first phase of the vulcanization process at step 14, the raw material in the mold forming apparatus is subjected to a furnace heat of about 190 degree centigrade for about 90 seconds, to create a first stage molded article. After the first phase of the vulcanization process at step 14, the mold is cooled, preferably to about room temperature, and the first stage molded article is taken out of the mold forming apparatus of step 12, and any extra or extraneous material from the first stage molded article is then trimmed at step 16. The first stage molded article that has been trimmed at step 16, is then placed in a furnace and prepared for a second phase of the vulcanization process at step 18. It is preferred, that at the second phase of the vulcanization process at step 18, the first stage molded and trimmed article is subjected to a furnace heat of about 200 degree centigrade for about 4 hours, to create a second stage molded article at step 18. The second stage molded article at step 18, is then taken out of the furnace and wiped and cleaned at step 20, thus creating the desired thin-walled, hollow pancake mold article at step 20. The process of manufacturing the thin-walled, hollow pancake mold article 23, could also include an optional step 22, which would be used to package the desired thin-walled, hollow pancake mold article of step 20, for packing and shipping to an end user or customer.

FIG. 2 is a perspective view of a first embodiment of a flexible, thin-walled, hollow pancake mold 33, manufactured according to the process 23, of this invention. The flexible, thin-walled, hollow pancake mold 33, is in a shape that has an outline shape of an airplane 33. The flexible, thin-walled, hollow pancake mold 33, preferably comprises of a continuous thin-wall 31, with an open or a hollow central area 35. It is also preferred that the flexible, thin-walled, hollow pancake mold 33, has at least one mold holding tab 32. The flexible, thin-walled, hollow pancake mold 33, could also have a second mold holding tab 34. The flexible, thin-walled, hollow pancake mold 33, is placed on top of a supporting surface (not shown), preferably a flat surface, and food ingredients (not shown), such as, a pancake mix is poured into the hollow central area 35. Care should be taken that the poured food ingredients do not spill over the top edges of the continuous thin-wall 31. The supporting surface is preferably any flat surface that can withstand the desired oven temperatures, as well as, prevent any food ingredients from escaping or seeping out of the base or bottom of the mold 33. The flexible, thin-walled, hollow pancake mold 33, along with the food ingredients and the supporting surface are placed inside an oven, and the food contents are cooked as desired. After the food contents within the hollow central area 35, have been cooked as desired, the mold 33, along with the supporting surface and the food contents is moved out of the oven, and the contents are allowed to cool, such as, to a room temperature, and the mold 33, can be lifted away from the food contents via the mold holding tabs 32, 34, leaving behind a shape which follows the inside contours of the continuous thin-wall 31, or the shape of the hollow central area 35.

FIG. 3 is a perspective view of a second embodiment of a flexible, thin-walled, hollow pancake mold 43, manufactured according to the process 23, of this invention. The flexible, thin-walled, hollow pancake mold 43, is in a shape that has an outline shape of an shoe 43. The flexible, thin-walled, hollow pancake mold 43, preferably comprises of a continuous thin-wall 41, with an open or a hollow central area 45. It is also preferred that the flexible, thin-walled, hollow pancake mold 43, has at least one mold holding tab 42. The flexible, thin-walled, hollow pancake mold 43, could also have a second mold holding tab 44. The flexible, thin-walled, hollow pancake mold 43, is placed on top of a supporting surface (not shown), preferably a flat surface, and food ingredients (not shown), such as, a pancake mix is poured into the hollow central area 45. Care should be taken that the poured food ingredients do not spill over the top edges of the continuous thin-wall 41. The supporting surface is preferably any flat surface that can withstand the desired oven temperatures, as well as, prevent any food ingredients from escaping or seeping out of the base or bottom of the mold 43. The flexible, thin-walled, hollow pancake mold 43, along with the food ingredients and the supporting surface are placed inside an oven, and the food contents are cooked as desired. After the food contents within the hollow central area 45, have been cooked as desired, the mold 43, along with the supporting surface and the food contents is moved out of the oven, and the contents are allowed to cool, such as, to a room temperature, and the mold 43, can be lifted away from the food contents via the mold holding tabs 42, 44, leaving behind a shape which follows the inside contours of the continuous thin-wall 41, or the shape of the hollow central area 45.

For some applications it is preferred that at the first phase of the vulcanization process at step 14, the raw material in the mold forming apparatus is subjected to a furnace heat of between about 180 degree centigrade to about 200 degree centigrade, and more preferably between about 185 degree centigrade to about 195 degree centigrade, and most preferably about 190 degree centigrade for about 90 seconds, to create the first stage molded article. Similarly, for some applications it is preferred that at the first phase of the vulcanization process at step 14, the heating of the raw material takes place for between about 80 seconds, to about 100 seconds, and more preferably between about 85 seconds, to about 95 seconds, and most preferably about 90 seconds.

For some applications it is preferred that at the second phase of the vulcanization process at step 18, the first stage molded and trimmed article is subjected to a furnace heat of between about 190 degree centigrade to about 210 degree centigrade, and more preferably between about 195 degree centigrade to about 205 degree centigrade, and most preferably about 200 degree centigrade for about 4 hours, to create the second stage molded article. Similarly, for some applications it is preferred that at the second phase of the vulcanization process at step 18, the heating of the first stage molded and trimmed article takes place for between about 3 hours and 45 minutes, to about 4 hours and 15 minutes, and more preferably about 4 hours.

It should be appreciated that the primary material for the flexible, thin-walled, hollow pancake mold article made via the process 23, is silicone, which provides a non-stick surface for most food ingredients. Furthermore, the silicone material is flexible and can easily accommodate standard oven cooking temperatures of up to about 200 degrees centigrade.

The material for the flexible, thin-walled, hollow pancake mold article made via the process 23, could be selected from a group comprising silicone, a food grade silicone, a silicone composite material, a high temperature resistant silicone composition, to name a few. The silicone used for this invention is preferably a food grade silicone. A food grade silicone is a type of silicone that is safe for use with foods. The food grade silicone is nontoxic, and does not stain food.

As one can appreciate, the flexible, thin-walled, hollow pancake mold article made via the process 23, is economically cheaper to manufacture than a comparable mold prepared from a metallic material or similar other material. The material used is lighter compared to a comparable metallic material, and so it can be inexpensively shipped. Furthermore, because the material used is flexible, the mold can withstand a substantial wear and tear during the shipment and use process.

The food ingredients that are poured inside the flexible, thin-walled, hollow pancake mold article made via the process 23, can be selected from a group comprising, a pancake mix, an omelet, eggs, a cake mix, a cookie mix, a liquid food material that firms up into a solid or a partial solid during the cooking process, a batter-type material, a liquid batter which subsequently solidifies during the cooking process, to name a few. It should be understood that the food ingredients could also include chunks or portions of solid food material within the liquid or batter-type food material.

For the purposes of illustration the flexible, thin-walled, hollow pancake mold, manufactured according to the process 23, has been shown as an airplane 33, and a shoe 43, however, for a person skilled in the art the flexible, thin-walled, hollow pancake mold, manufactured according to the process 23, could be selected from a group comprising a foot, a bunny rabbit, a bat, a Christmas tree, an angel, a lip, an irregular shape, to name a few.

The continuous thin-wall 31, 41, could be substantially vertical. However, for some applications it is preferred that the continuous thin-wall 31, 41, has a taper that starts from a top edge of the continuous thin-wall 31, 41, and goes to the bottom edge of the continuous thin-wall 31, 41. The taper could be in an inwardly direction or an outwardly direction. The taper could be on the inside wall or on the outside wall of the continuous thin-wall 31, 41.

For some applications the flexible, thin-walled, hollow pancake mold article 33, 43, having the continuous thin-wall 31, 41, could have a substantially flat central supporting surface 35, 45, instead of the open or the hollow central area 35, 45. The supporting surface 35, 45, preferably a flat surface, could be used to accommodate food ingredients, such as, a pancake mix, that may be poured into the central surface area 35, 45, of the flexible, thin-walled, hollow pancake mold article 33, 43.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A process for manufacturing a flexible, thin-walled, hollow pancake mold article, comprising the steps of:
(a) pouring silicone in a container, and spinning said silicone to form a spun silicone material;
(b) pouring said spun silicone material inside at least one cavity of a mold forming apparatus, wherein said at least one cavity is in the shape of a thin-walled, hollow pancake mold article;
(c) placing said mold forming apparatus inside a furnace, and heating it for a first set time and a first set temperature, to perform a first vulcanization phase on said spun silicone material;
(d) removing said mold forming apparatus from said furnace after said first set time and said first set temperature;
(e) removing said spun silicone material from said at least one cavity of said mold forming apparatus after said first vulcanization phase;
(f) placing said spun silicone material in a furnace to perform a second vulcanization phase for a second set time and a second set temperature; and
(g) removing said spun silicone material from said furnace after said second vulcanization phase, and thereby forming said flexible, thin-walled, hollow pancake mold article.

2. The process for manufacturing a flexible, thin-walled, hollow pancake mold article, of claim 1, wherein at least one color is mixed with said silicone prior to said spinning process of step (a).

3. The process for manufacturing a flexible, thin-walled, hollow pancake mold article, of claim 1, wherein said silicone is selected from a group consisting of a food grade silicone, a silicone composite material, and a high temperature resistant silicone composition.

4. The process for manufacturing a flexible, thin-walled, hollow pancake mold article, of claim 1, wherein at least one additional material is mixed with said silicone prior to said spinning process of step (a).

5. The process for manufacturing a flexible, thin-walled, hollow pancake mold article, of claim 1, wherein extraneous material is trimmed from said spun silicone material after said spun silicone material is removed from said at least one cavity in step (e).

6. The process for manufacturing a flexible, thin-walled, hollow pancake mold article, of claim 1, wherein said flexible, thin-walled, hollow pancake mold article is wiped and cleaned after step (g).

7. The process for manufacturing a flexible, thin-walled, hollow pancake mold article, of claim 1, wherein said flexible, thin-walled, hollow pancake mold article is placed inside a package after step (g).

8. The process for manufacturing a flexible, thin-walled, hollow pancake mold article, of claim 1, wherein said mold forming apparatus is heated inside said furnace in step (c) for between about 180 degree centigrade to about 200 degree centigrade, and more preferably between about 185 degree centigrade to about 195 degree centigrade, and most preferably about 190 degree centigrade, for about 90 seconds.

9. The process for manufacturing a flexible, thin-walled, hollow pancake mold article, of claim 1, wherein said mold forming apparatus is heated inside said furnace in step (c) for between about 180 degree centigrade to about 200 degree centigrade, and more preferably between about 185 degree centigrade to about 195 degree centigrade, and most preferably about 190 degree centigrade, and for between about 80 seconds, to about 100 seconds, and more preferably between about 85 seconds, to about 95 seconds, and most preferably about 90 seconds.

10. The process for manufacturing a flexible, thin-walled, hollow pancake mold article, of claim 1, wherein said spun silicone material is heated inside said furnace in step (f) for between about 190 degree centigrade to about 210 degree centigrade, and more preferably between about 195 degree centigrade to about 205 degree centigrade, and most preferably about 200 degree centigrade, for about 4 hours.

11. The process for manufacturing a flexible, thin-walled, hollow pancake mold article, of claim 1, wherein said spun silicone material is heated inside said furnace in step (f) for between about 190 degree centigrade to about 210 degree centigrade, and more preferably between about 195 degree centigrade to about 205 degree centigrade, and most preferably about 200 degree centigrade, and for between about 3 hours and 45 minutes, to about 4 hours and 15 minutes, and more preferably about 4 hours.

12. The process for manufacturing a flexible, thin-walled, hollow pancake mold article, of claim 1, wherein said spun silicone material of step (g) can withstanding temperatures of up to about 200 degrees centigrade.

13. The process for manufacturing a flexible, thin-walled, hollow pancake mold article, of claim 1, wherein said spun silicone material of step (g) has a continuous thin-wall, and an open hollow central area.

14. The process for manufacturing a flexible, thin-walled, hollow pancake mold article, of claim 1, wherein said spun silicone material of step (g) has an outline shape selected from a group consisting of an airplane, a shoe, a foot, a bunny rabbit, a bat, a Christmas tree, an angel, a lip, and an irregular shape.

15. The process for manufacturing a flexible, thin-walled, hollow pancake mold article, of claim 1, wherein said spun silicone material of step (g) has an outline shape selected from a group consisting of an airplane, a shoe, a foot, a bunny rabbit, a bat, a Christmas tree, an angel, a lip, and an irregular shape, and wherein said spun silicone material of step (g) has a continuous thin-wall, and an open hollow central area.

16. The process for manufacturing a flexible, thin-walled, hollow pancake mold article, of claim 1, wherein said spun silicone material of step (g) has a continuous thin-wall, an open hollow central area, and at least one mold holding tab affixed to at least an upper portion of said continuous thin-wall.

17. The process for manufacturing a flexible, thin-walled, hollow pancake mold article, of claim 1, wherein said spun silicone material of step (g) has a continuous thin-wall, an open hollow central area, and wherein said continuous thin-wall has a taper that starts from a top edge of said continuous thin-wall and goes to the bottom edge of said continuous thin-wall.

18. The process for manufacturing a flexible, thin-walled, hollow pancake mold article, of claim 1, wherein said spun silicone material of step (g) has a continuous thin-wall, and a substantially flat central supporting surface.

19. A process for manufacturing a flexible, thin-walled, hollow pancake mold article, comprising the steps of:
(a) pouring silicone and at least one color in a container, and spinning said silicone and said at least one color, and forming a colored spun silicone material;
(b) pouring said colored spun silicone material inside at least one cavity of a mold forming apparatus, wherein said at least one cavity is in the shape of a thin-walled, hollow pancake mold article;
(c) placing said mold forming apparatus inside a furnace, and heating it for at least about 90 seconds, and to a temperature of at least about 190 degrees centigrade, to perform a first vulcanization phase on said colored spun silicone material;
(d) removing said mold forming apparatus from said furnace after said first vulcanization phase;
(e) removing said colored spun silicone material from said at least one cavity of said mold forming apparatus after said first vulcanization phase;
(f) placing said colored spun silicone material in a furnace to perform a second vulcanization phase for at least about four hours, at a temperature of at least about 200 degrees centigrade; and
(g) removing said colored spun silicone material from said furnace after said second vulcanization phase, and thereby forming said flexible, thin-walled, hollow pancake mold article.

20. A product made by the process of manufacturing a flexible, thin-walled, hollow pancake mold article, comprising the steps of:
(a) pouring silicone and at least one color in a container, and spinning said silicone having said at least one color, and forming a colored spun silicone material;
(b) pouring said colored spun silicone material inside at least one cavity of a mold forming apparatus, wherein said at least one cavity is in the shape of a thin-walled, hollow pancake mold article;
(c) placing said mold forming apparatus inside a furnace, and heating it for at least about 90 seconds, and to a temperature of at least about 190 degrees centigrade, to perform a first vulcanization phase on said colored spun silicone material;
(d) removing said mold forming apparatus from said furnace after said first vulcanization phase;
(e) removing said colored spun silicone material from said at least one cavity of said mold forming apparatus after said first vulcanization phase, and trimming said colored spun silicone material;
placing said trimmed colored spun silicone material in a furnace to perform a second vulcanization phase for at least about four hours, at a temperature of at least about 200 degrees centigrade; and
(g) removing said trimmed colored spun silicone material from said furnace after said second vulcanization phase, and wiping and cleaning said trimmed colored spun silicone material, and thereby making said product made by the process of manufacturing a flexible, thin-walled, hollow pancake mold article.
